(19) United States
(12) Patent Application Publication
(10) Pub. No.: US 2015/0073963 A1
(43) Pub. Date: Mar. 12, 2015

(54) Matching with Level Residual Allocation

(71) Applicant: Chicago Mercantile Exchange Inc., Chicago, IL (US)

(72) Inventors: Troy McDonald Kane, Chicago, IL (US); Brian M. Wolf, Roselle, IL (US)

(73) Assignee: Chicago Mercantile Exchange Inc., Chicago, IL (US)

(21) Appl. No.: 14/024,467

(22) Filed: Sep. 11, 2013

(51) Int. Cl. G06Q 40/04

(52) U.S. Cl. CPC G06Q 40/04
USPC 705/37

(57) ABSTRACT

The disclosed embodiments relate to systems and methods which match/allocate an incoming order to trade with “resting,” i.e. previously received but not yet matched, orders. A primary volume of the aggressor order is allocated to a first subset of orders of the set of previously received orders based on a first matching procedure in partial satisfaction of the aggressor order. A residual volume of the aggressor order remaining after the partial satisfaction of the aggressor order is computed. Unfilled orders of the set of previously received orders are arranged in a ranking based on a second matching procedure independent of order size. A predetermined, level quantity of the aggressor order is allocated to each order in a second subset of the set of previously received orders in accordance with the ranking until the residual volume is exhausted.

### BACKGROUND

A financial instrument trading system, such as a futures exchange, referred to herein also as an “Exchange”, such as the Chicago Mercantile Exchange Inc. (CME), provides a contract market where financial products/instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time, referred to as the expiration date or expiration month. An option is the right, but not the obligation, to sell or buy the underlying instrument (in this case, a futures contract) at a specified price within a specified time. The commodity to be delivered in fulfillment of the contract, or alternatively, the commodity, or other instrument/asset, for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract price.

Typically, the Exchange provides for a centralized “clearing house” through which all trades made must be confirmed, matched, and settled each day until offset or delivered. The clearing house is an adjunct to the Exchange, and may be an operating division thereof, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Current financial instrument trading systems allow traders to submit orders and receive confirmations, market data, and other information electronically via a network. These “electronic” marketplaces have largely supplanted the pit based trading systems whereby the traders, or their representatives, all physically stand in a designated location, i.e. a trading pit, and trade with each other via oral and hand based communication. In contrast to the pit based trading system where like-minded buyers and sellers can readily find each other to trade, electronic marketplaces must electronically “match” the orders placed by buyers and sellers on behalf thereof. Electronic trading systems may offer a more efficient and transparent system of trading. For example, in pit trading, subjective elements and limits on human interaction may unduly influence the process by which buyers and sellers come together to trade or otherwise limit the trading opportunities, limiting market liquidity. In contrast, an electronic exchange may be more objective when matching up a buyer and seller, relying solely on objective factors such as price and time of order placement, etc. As such, electronic trading systems may achieve more fair and equitable matching among traders as well as identify more opportunities to trade, thereby improving market liquidity.

### BRIEF DESCRIPTION OF THE DRAWINGS

FIG. 1 depicts an illustrative computer network system that may be used to implement aspects of the disclosed embodiments.

FIG. 2 a block diagram of an exemplary implementation of the system of FIG. 1 for level allocation of residual volume in accordance with one embodiment.

FIG. 3 depicts a flow chart showing operation of the system of FIGS. 1 and 2.

FIG. 4 shows an illustrative embodiment of a general computer system for use with the system of FIGS. 1 and 2.

FIGS. 5A and 5B depict general application of the system of FIG. 2 with leveling principles according to two embodiments.

### DETAILED DESCRIPTION

The disclosed embodiments relate to systems and methods which match or otherwise allocate an incoming order to trade with “resting,” i.e. previously received but not yet matched, orders, after an initial allocation. The disclosed embodiments relate to a match engine that allocates residual trade volumes remaining after an initial or primary allocation. The residual trade volumes are allocated in accordance with a leveling procedure that ranks market participants independently of order size. For instance, the residual trade volumes may be allocated in accordance with a leveling procedure that ranks orders unfilled by the initial allocation using a time-based or random procedure.

The disclosed embodiments may provide and promote more widespread participation in markets. The allocation of residual volume in accordance with the disclosed embodiments may also deter market participants from placing orders with an artificially high quantity, in the interest of enhancing the probability that the order will be filled in accordance with size dependent algorithms. While the disclosed embodiments may be useful in connection with addressing the effects of pro rata- or other order-size-based allocations, the disclosed embodiments may use an initial allocation configured in accordance with a variety of different matching algorithms or procedures.

The disclosed embodiments may be directed to allocating the residual volume remaining from an aggressor order after an initial or primary allocation. The initial allocation may include or involve multiple rounds or passes, with each applying a different matching algorithm or procedure. One example of a multiple round primary allocation uses a Split FIFO/Pro Rata algorithm. The disclosed embodiments may rank or prioritize any orders that remain unfilled by time stamp (e.g., FIFO), randomly, or by some other algorithm, procedure, or principle. A predetermined, level quantity (e.g., a 1-lot) is then allocated to each order until the residual volume of the aggressor order is exhausted.

While the disclosed embodiments may be discussed in relation to futures and/or options on futures trading, it will be appreciated that they may be applicable to any equity, options or futures trading system, e.g., exchange, Electronic Communication Network (“ECN”), Alternative Trading System (“ATS”), or Swap Execution Facility (“SEF”), or market now available or later developed, e.g. cash, Futures, etc., as well as any instrument traded thereon. It will be appreciated that a trading environment, such as a futures exchange as described herein, implements one or more economic markets where rights and obligations may be traded. As such, a trading environment may be characterized by a need to maintain market integrity, transparency, predictability, fair/equitable access and participant expectations with respect thereto. For example, an exchange must respond to inputs, such as trader orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. In addition, it will be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participants are met, e.g. that transactional integrity and predictable system responses are maintained.

As was discussed above, electronic trading systems ideally attempt to offer an objective, efficient, fair and balanced market where market prices reflect a true consensus of the value of products traded among the market participants, where the intentional or unintentional influence of human interaction is minimized, if not eliminated, and where unfair or inequitable advantages with respect to information access are minimized if not eliminated.

Further, as discussed above, an exchange provides one or more markets for the purchase and sale of various types of products including financial instruments such as stocks, bonds, futures contracts, options, currency, cash, and other similar instruments. Agricultural products and commodities are also examples of products traded on such exchanges. A futures contract is a product that is a contract for the future delivery of another financial instrument such as a quantity of grains, metals, oils, bonds, currency, or cash. Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates. As will be described, the Exchange may further define the matching algorithm, or rules, by which incoming orders will be matched/allocated to resting orders.

Some products on an exchange are traded in an open outcry environment where the exchange provides a location for buyers and sellers to meet and negotiate a price for a quantity of a product. Other products are traded on an electronic trading platform (e.g., an electronic exchange), also referred to herein as a trading platform, trading host or Exchange Computer System, where market participants, e.g. traders, use software to send orders to the trading platform. The order identifies the product, the quantity of the product the trader wishes to trade, a price at which the trader wishes to trade the product, and a direction of the order (i.e., whether the order is a bid, i.e. an offer to buy, or an ask, i.e. an offer to sell).

The Exchange Computer System, as will be described below, monitors incoming orders received thereby and attempts to identify, i.e., match or allocate, as will be described in more detail below, one or more previously received, but not yet matched, orders, i.e. limit orders to buy or sell a given quantity at a given price, referred to as “resting” orders, stored in an order book database, wherein each identified order is contra to the incoming order and has a favorable price relative to the incoming order. An incoming order may be an “aggressor” order, i.e., a market order to sell a given quantity at whatever may be the resting bid order price(s) or a market order to buy a given quantity at whatever may be the resting ask order price(s). In particular, if the incoming order is a bid, i.e. an offer to buy, then the identified order(s) will be an ask, i.e. an offer to sell, at a price that is identical to or lower than the bid price. Similarly, if the incoming order is an ask, i.e. an offer to sell, the identified order(s) will be a bid, i.e. an order to buy, at a price that is identical to or higher than the offer price.

Upon identification (matching) of a contra order(s), a minimum of the quantities associated with the identified order and the incoming order is matched and that quantity of each of the identified and incoming orders become two halves of a matched trade that is sent to a clearinghouse. The Exchange Computer System considers each identified order in this manner until either all of the identified orders have been considered or all of the quantity associated with the incoming order has been matched, i.e. the order has been filled. If any quantity of the incoming order remains, an entry may be created in the order book database and information regarding the incoming order is recorded therein, i.e. a resting order is placed on the order book for the remaining quantity to await a subsequent incoming order counter thereto.

Traders access the markets on a trading platform using trading software that receives and displays at least a portion of the order book for a market, i.e. at least a portion of the currently resting orders. The trading software enables a trader to provide parameters for an order for the product traded in the market, and transmits the order to the Exchange Computer System. The trading software typically includes a graphical user interface to display at least a price and quantity of some of the entries in the order book associated with the market. The number of entries of the order book displayed is generally preconfigured by the trading software, limited by the Exchange Computer System, or customized by the user. Some graphical user interfaces display order books of multiple markets of one or more trading platforms. The trader may be an individual who trades on his/her behalf, a broker trading on behalf of another person or entity, a group, or an entity. Furthermore, the trader may be a system that automatically generates and submits orders.

If the Exchange Computer System identifies that an incoming market order may be filled by a combination of multiple resting orders, e.g. the resting order(s) at the best price only partially fills the incoming order, the Exchange Computer System may allocate the remaining quantity of the incoming, i.e. that which was not filled by the resting order(s) at the best price, among such identified orders in accordance with prioritization and allocation rules/algorithms, referred to as “matching algorithms” or “matching procedures,” as, for example, may be defined in the specification of the particular financial product or defined by the Exchange for multiple financial products. Similarly, if the Exchange Computer System identifies multiple orders contra to the incoming limit order and that have an identical price which is favorable to the price of the incoming order, i.e. the price is equal to or better, e.g. lower if the incoming order is a buy or higher if the incoming order is a sell, than the price of the incoming order, the Exchange Computer System may allocate the quantity of the incoming order among such identified orders in accordance with the matching algorithms as, for example, may be defined in the specification of the particular financial product or defined by the Exchange for multiple financial products.

As was noted above, an Exchange responds to inputs, such as trader orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. Accordingly, the method by which incoming orders are matched with resting orders must be defined so that traders know what the expected result will be when they place an order or have resting orders and an incoming order is received. Typically, the Exchange defines the matching algorithm that will be used for a particular financial product, with or without input from the market participants. Once defined for a particular product, the matching algorithm is typically not altered, except in limited circumstance, such as to correct errors or improve operation, so as not to disrupt trader expectations. It will be appreciated that different products offered by a particular Exchange may use different matching algorithms.

For example, a first-in/first-out (FIFO) matching algorithm, also referred to as a “Price Time” algorithm, considers each identified order sequentially in accordance with when the identified order was received. A FIFO or Price Time algorithm considers the timestamp of each order in the order book. The quantity of the incoming order is matched to the quantity of the identified order received earliest, then quantities of the next earliest, and so on until the quantity of the incoming order is exhausted.

Some product specifications define the use of a pro-rata matching algorithm, where a quantity of an incoming order is allocated to each of a plurality of identified orders proportionally. Some Exchange Computer Systems provide a priority to certain standing orders in particular markets. An example of such an order is the first order that improves a price (i.e., improves the market) for the product during a trading session. To be given priority, the trading platform may require that the quantity associated with the order is at least a minimum quantity. Further, some Exchange Computer Systems cap the quantity of an incoming order that is allocated to a standing order on the basis of a priority for certain markets. In addition, some Exchange Computer Systems may give a preference to orders submitted by a trader who is designated as a market maker for the product. Other Exchange Computer Systems may use other criteria to determine whether orders submitted by a particular trader are given a preference. Typically, when the Exchange Computer System allocates a quantity of an incoming order to a plurality of identified orders at the same price, the trading host allocates a quantity of the incoming order to any orders that have been given priority. The Exchange Computer System thereafter allocates any remaining quantity of the incoming order to orders submitted by traders designated to have a preference, and then allocates any still remaining quantity of the incoming order using the FIFO or pro-rata algorithms. Pro-rata algorithms used in some markets may require that an allocation provided to a particular order in accordance with the pro-rata algorithm must meet at least a minimum allocation quantity. Any orders that do not meet or exceed the minimum allocation quantity are allocated on a FIFO basis after the pro-rata allocation (if any quantity of the incoming order remains). More information regarding order allocation may be found in U.S. Pat. No. 7,853,499, the entire disclosure of which is incorporated by reference.

Other examples of matching algorithms which may be defined for allocation of orders of a particular financial product include:
Price Explicit Time
Order Level Pro Rata
Order Level Priority Pro Rata
Preference Price Explicit Time
Preference Order Level Pro Rata
Preference Order Level Priority Pro Rata
Threshold Pro-Rata
Priority Threshold Pro-Rata
Preference Threshold Pro-Rata
Priority Preference Threshold Pro-Rata
Split Price-Time Pro-Rata

For example, the Price Explicit Time trading policy is based on the basic Price Time trading policy with Explicit Orders having priority over Implied Orders at the same price level. The order of traded volume allocation at a single price level may therefore be:
Explicit order with oldest timestamp first. Followed by
Any remaining explicit orders in timestamp sequence (First In, First Out—FIFO) next. Followed by
Implied order with oldest timestamp next. Followed by
Any remaining implied orders in timestamp sequence (FIFO).

In Order Level Pro Rata, also referred to as Price Pro Rata, priority is given to orders at the best price (highest for a bid, lowest for an offer). If there are several orders at this best price, equal priority is given to every order at this price and incoming business is divided among these orders in proportion to their order size. The Pro Rata sequence of events is:
1. Extract all potential matching orders at best price from the order book into a list.
2. Sort the list by order size, largest order size first. If equal order sizes, oldest timestamp first. This is the matching list.
3. Find the ‘Matching order size’, which is the total size of all the orders in the matching list.
4. Find the ‘tradable volume’, which is the smallest of the matching volume and the volume left to trade on the incoming order.
5. Allocate volume to each order in the matching list in turn, starting at the beginning of the list. If all the tradable volume gets used up, orders near the end of the list may not get allocation.
6. The amount of volume to allocate to each order is given by the formula:

(Order volume/Matching volume)*Tradable volume
The result is rounded down (for example, 21.99999999 becomes 21) unless the result is less than 1, when it becomes 1.
7. If tradable volume remains when the last order in the list had been allocated to, return to step 3.
   Note: The matching list is not re-sorted, even though the volume has changed. The order which originally had the largest volume is still at the beginning of the list.
8. If there is still volume left to trade on the incoming order, repeat the entire algorithm at the next price level.

Order Level Priority Pro Rata, also referred to as Threshold Pro Rata, is similar to the Price (or ‘Vanilla’) Pro Rata algorithm but has a volume threshold defined. Any pro rata allocation below the threshold will be rounded down to 0. The initial pass of volume allocation is carried out in using pro rata; the second pass of volume allocation is carried out using Price Explicit Time. The Threshold Pro Rata sequence of events is:
1. Extract all potential matching orders at best price from the order book into a list.
2. Sort the list by explicit time priority, oldest timestamp first. This is the matching list.
3. Find the ‘Matching volume’, which is the total volume of all the orders in the matching list.
4. Find the ‘tradable volume’, which is the smallest of the matching volume and the volume left to trade on the incoming order.
5. Allocate volume to each order in the matching list in turn, starting at the beginning of the list.
6. The amount of volume to allocate to each order is given by the formula:

(Order volume/Matching volume)*Tradable volume
The result is rounded down to the nearest lot (for example, 21.99999999 becomes 21) unless the result is less than the defined threshold in which case it is rounded down to 0.
7. If tradable volume remains when the last order in the list had been allocated to, the remaining volume is allocated in time priority to the matching list.
8. If there is still volume left to trade on the incoming order, repeat the entire algorithm at the next price level.

In the Split Price Time Pro-Rata algorithms, a Price Time Percentage parameter is defined. This percentage of the matching volume at each price is allocated by the Price Explicit Time algorithm and the remainder is allocated by the Threshold Pro-Rata algorithm. There are four variants of this algorithm, with and without Priority and/or Preference. The Price Time Percentage parameter is an integer between 1 and 99. (A percentage of zero would be equivalent to using the respective existing Threshold Pro-Rata algorithm, and a percentage of 100 would be equivalent to using the respective existing Price Time algorithm). The Price Time Volume will be the residual incoming volume, after any priority and/or Preference allocation has been made, multiplied by the Price Time Percentage. Fractional parts will be rounded up, so the Price Time Volume will always be at least 1 lot and may be the entire incoming volume. The Price Time Volume is allocated to resting orders in strict time priority. Any remaining incoming volume after the Price Time Volume has been allocated will be allocated according to the respective Threshold Pro-Rata algorithm. The sequence of allocation, at each price level, is therefore:
1. Priority order. if applicable
2. Preference allocation, if applicable
3. Price Time allocation of the configured percentage of incoming volume
4. Threshold Pro-Rata allocation of any remaining incoming volume
5. Final allocation of any leftover lots in time sequence.
   Any resting order may receive multiple allocations from the various stages of the algorithm.

Although described below in connection with a split Price Time (or FIFO)-Pro Rata matching algorithm, the disclosed embodiments may be use any of the above-identified matching algorithms or procedures as a primary matching algorithm or procedure. It will be appreciated that there may be other allocation algorithms, including combinations of algorithms, now available or later developed, which may be utilized with the disclosed embodiments, and all such algorithms are contemplated herein.

The matching algorithm may influence the behavior of the market or individual traders. For example, some allocation algorithms may encourage traders to submit more orders, where each order is relatively small. Other matching algorithms encourage traders to submit larger orders. Other matching algorithms may encourage a trader to use an electronic trading system that can monitor market activity and submit and retract orders on behalf of the trader very quickly and without intervention.

The disclosed embodiments may be useful in encouraging each of these and other types of traders to participate in the market. For instance, the disclosed embodiments may provide order allocations that do not solely favor large traders or traders that leave orders on the order book for an extended period of time.

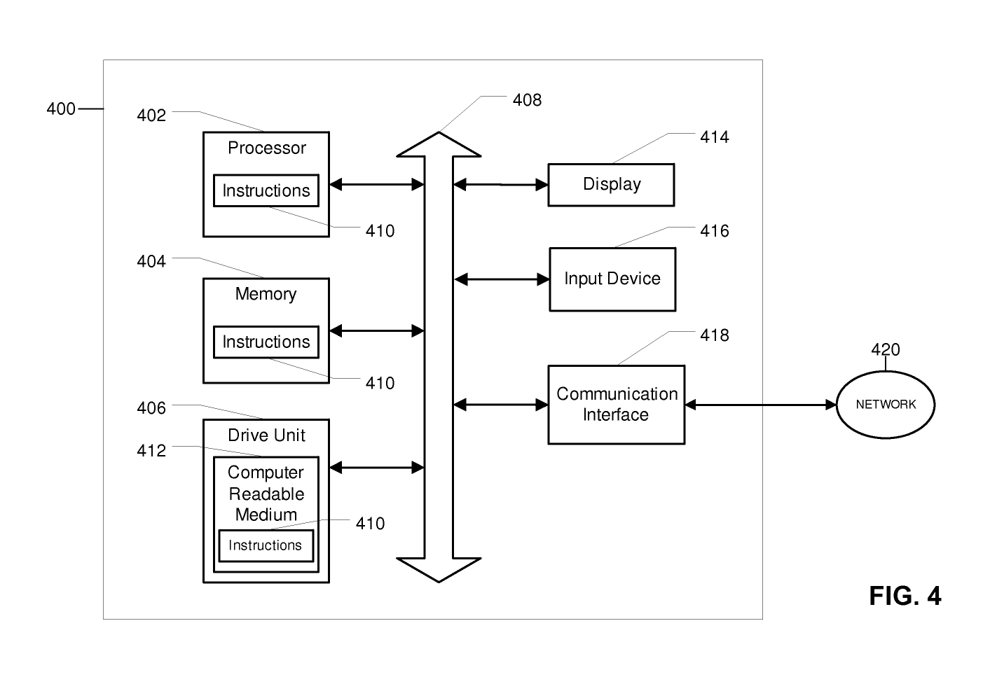

The disclosed embodiments may be implemented with computer devices and computer networks, such as those described with respect FIG. 4, that allow users, e.g. market participants or traders, to exchange trading information. It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange.

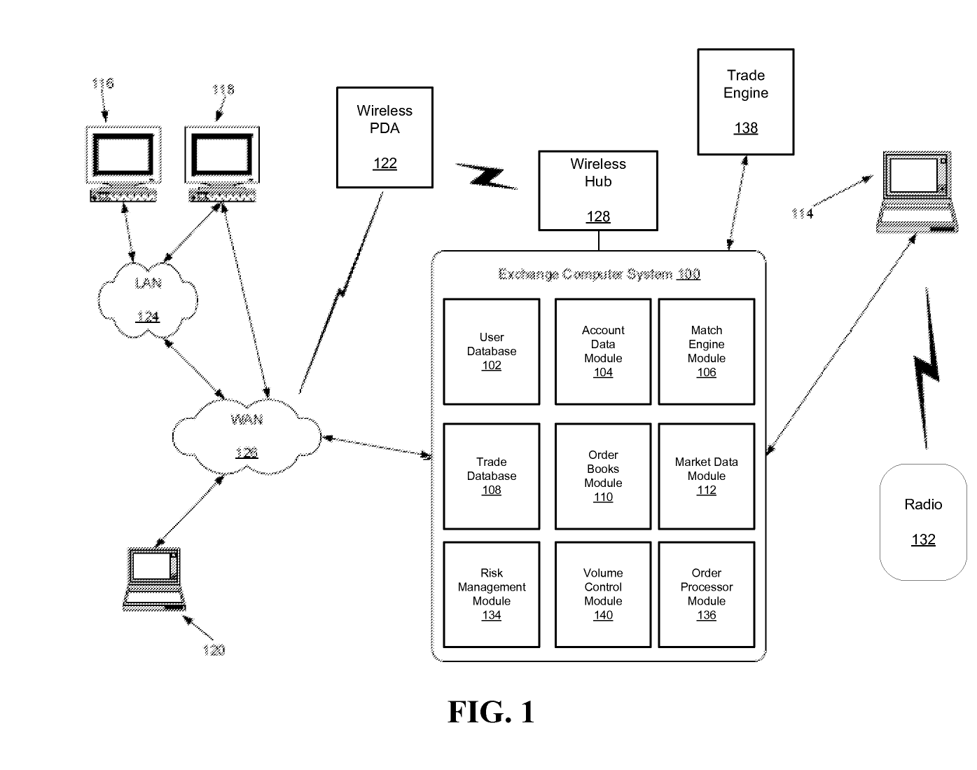

An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

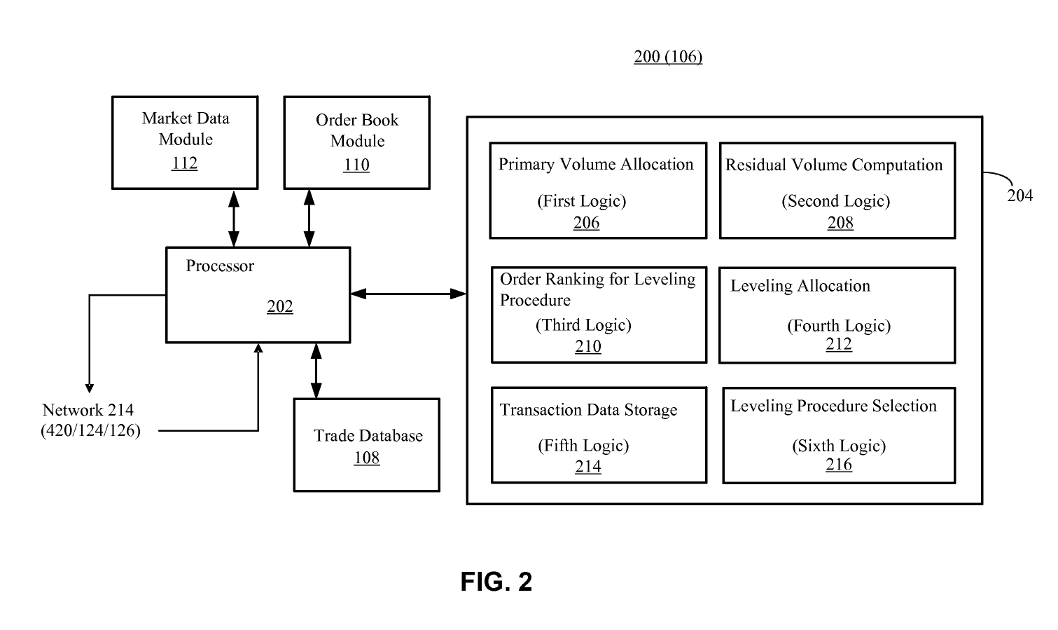

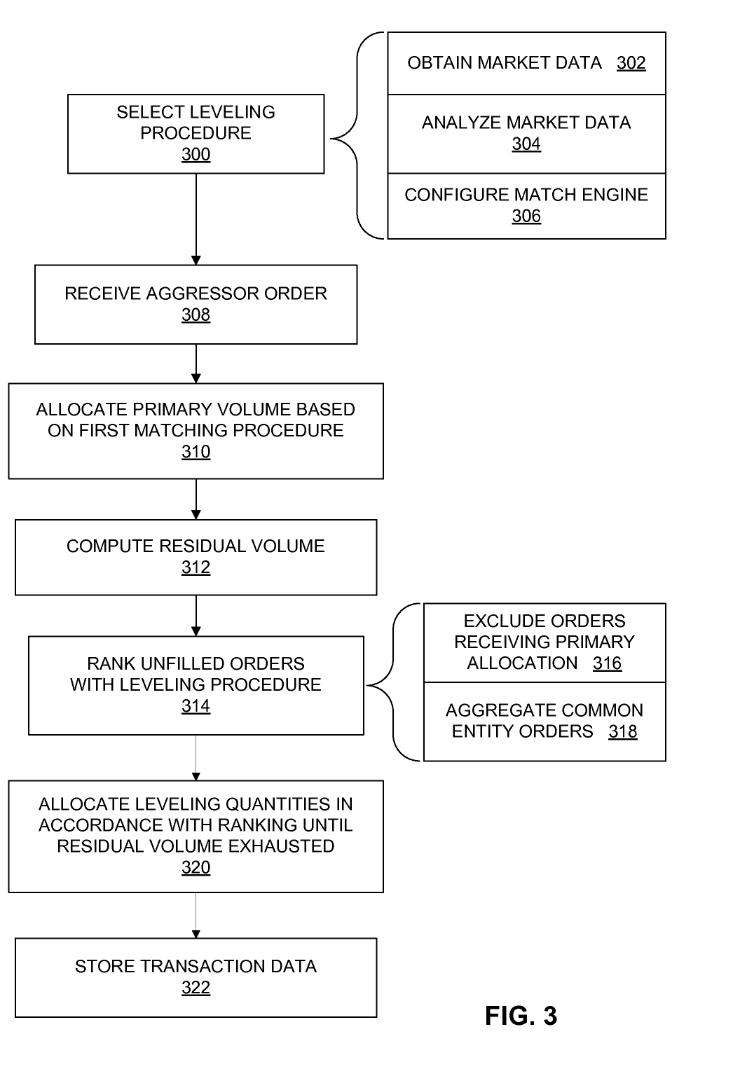

The exchange computer system 100 may be implemented with one or more mainframe, desktop or other computers, such as the computer 400 described below with respect to FIG. 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes algorithms for matching bids and offers as will be described in more detail below in connection with FIGS. 2 and 3. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by the order book module 110 and/or match engine module 106. A volume control module 140 may be included to, among other things, control the rate of acceptance of mass quote messages in accordance with one or more aspects of the disclosed embodiments. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122 which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based computer device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As was described above, the users of the exchange computer system 100 may include one or more market makers which may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a computer-readable storage medium (as opposed to computer-readable communication media involving propagating signals) or a non-transitory computer-readable storage medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

FIG. 2 is a block diagram to depict the match engine module 106 according to one embodiment, which in an exemplary implementation, is implemented as part of the exchange computer system 100 described above. As used herein, an exchange 100 includes a place or system that receives and/or executes orders.

FIG. 2 shows a system 200 for matching, or otherwise allocating, an incoming or other aggressor order for a quantity of a financial product with one or more of a set of previously received unmatched (i.e., resting) orders for the financial product that are counter to the aggressor order, e.g. at the same or better price than the aggressor order. In one embodiment, the financial product is a derivative product such as a futures contract or option contract on a futures contract. Alternatively, or in addition thereto, the financial product may include a cash-market instrument, such as a swap. The system 200 includes a processor 202 and a memory 204 coupled therewith which may be implemented a processor 402 and memory 404 as described below with respect to FIG. 4.

During operation, the processor 202 may access the order book module 110 to obtain or receive data indicative of the resting orders and the incoming or aggressor order. The data may be accessed at the outset, e.g., before implementation of the matching procedures, and/or during such implementation as needed. In some cases, the data may be temporarily stored in the memory 404 and/or another memory for use during operation. Temporary or other data generated during operation may also be stored in the memory 404 and/or another memory.

The system 200 includes first logic 206 stored in the memory 204 and executable by the processor 202 to cause the processor 202 to allocate a primary volume of the aggressor order to a first subset of orders of the set of previously received orders based on a first matching procedure in partial satisfaction of the aggressor order. The first matching procedure may be configured to cause the processor to implement an algorithm dependent upon order size. Examples of matching procedures that are dependent upon order size include those that implement pro rata algorithms.

The first matching procedure may be configured to implement any one or more of the above-identified matching algorithms. In some cases, the first matching procedure includes multiple allocation rounds or passes. For example, the first matching procedure may be configured to cause the processor 202 to implement an initial matching round in accordance with a FIFO algorithm and a subsequent matching round in accordance with a pro-rata algorithm.

The system 200 further includes second logic 208 stored in the memory 204 and executable by the processor 202 to cause the processor 202 to compute a residual volume of the aggressor order remaining after the partial satisfaction of the aggressor order. The computation may include or involve subtracting the allocation quantity of the primary volume from the quantity of the aggressor order.

The system 200 further includes third logic 210 stored in the memory 204 and executable by the processor 202 to cause the processor 202 to arrange unfilled orders of the set of previously received orders in a ranking based on a second matching procedure independent of order size. The ranking will be used to prioritize the resting orders for a leveling allocation procedure described below. The ranking may thus provide an incentive for smaller traders (or those market participants less likely to place large orders) to participate in a market. In some cases, the second matching procedure is configured to cause the processor to rank the unfilled orders in accordance with the timestamps of the unfilled orders, as in a FIFO algorithm. In other cases, the second matching procedure is configured to cause the processor to rank the unfilled orders randomly. Other algorithms or principles may be applied or used in the second matching procedure.

In one embodiment, the third logic 210 is further executable by the processor 202 to cause the processor 202 to aggregate orders of the unfilled orders in the ranking that originate from a common entity. Order aggregation may be implemented to decrease the likelihood that market participants would artificially place multiple orders instead of a single order of greater size. Aggregation may be useful in connection with a random matching procedure, but may also be used with other matching procedures used by the third logic 210.

In one embodiment, the third logic 210 is further executable by the processor 202 to cause the processor 202 to exclude from the ranking an order of the unfilled orders belonging to the first subset. Exclusion of the orders receiving an allocation in the primary allocation may support broader participation in a market.

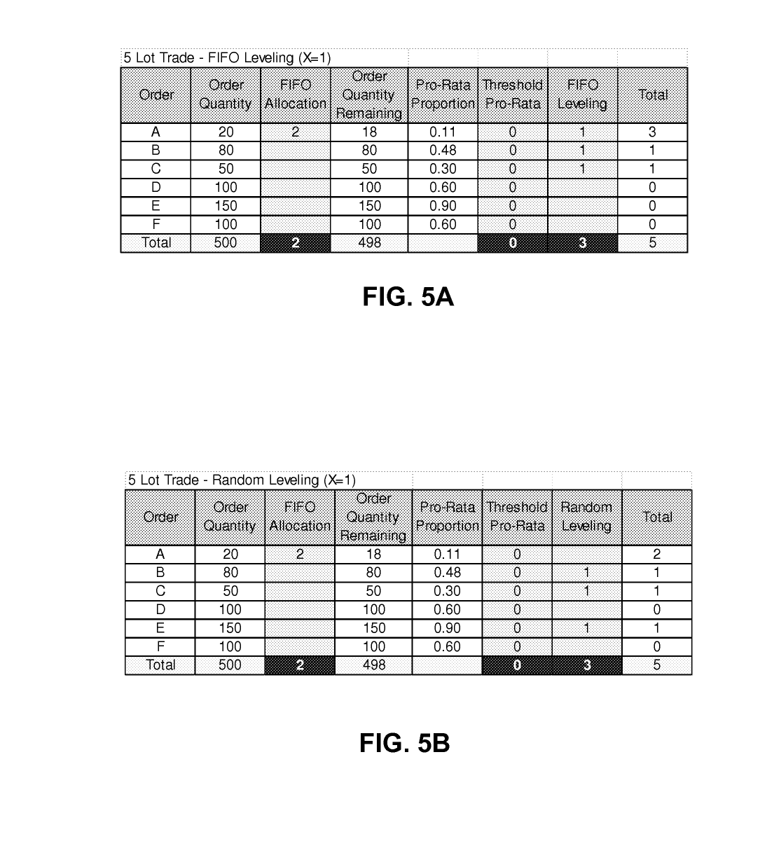

The system 200 further includes fourth logic 212 stored in the memory 204 and executable by the processor 202 to cause the processor 202 to allocate a predetermined, level quantity of the aggressor order to each order in a second subset of the set of previously received orders in accordance with the ranking until the residual volume is exhausted. For example, the fourth logic 212 may allocate a 1-lot to each order until the residual volume is exhausted. The predetermined, level quantity may be other quantities. Examples of the allocation of level quantities are described below in connection with FIGS. 5A and 5B.

The system 200 further includes fifth logic 214 stored in the memory 204 and executable by the processor 202 to cause the processor 202 to store transaction data indicative of trades of the financial product to be executed with the first and second subsets of the set of previously received orders. In the embodiment of FIG. 2, the transaction data is stored in the trade database 108. Alternative or additional storage locations may be used.

In one embodiment, the system 200 may further include sixth logic 216 stored in the memory 204 and executable by the processor 202 to cause the processor 202 to select the second matching procedure from a plurality of leveling procedures. The sixth logic 216 may be implemented at any time. For example, a leveling procedure may be selected at the beginning or end of a trading day. Other intervals may be used. The leveling procedure may be alternatively or additionally during a trading session before initiating an allocation (e.g., in between allocations).

The sixth logic 216 may be configured to cause the processor 202 to access the market data module 112 to obtain data indicative of market activity, conditions, or other characteristics.

In one embodiment, the first matching procedure may be or include a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

FIG. 3 depicts a flow chart showing operation of the system 200 of FIG. 2. In particular, FIG. 3 shows a computer implemented method for matching, or otherwise allocating, an aggressor order for a quantity of a financial product with one or more of a set of previously received unmatched orders for the financial product that are counter to the aggressor order, e.g. at the same or better price than the first order. The financial product may vary as described above. The order of the acts or steps of the operation may vary from the example shown. For example, a leveling procedure may be selected after receipt of an aggressor order or at other times during the operation. Additional, fewer, or alternative acts may be implemented. For example, the leveling procedure may be previously selected or otherwise established.

The operation includes selecting a leveling procedure for use in the matching method [block 300]. Multiple leveling procedures may be available, as described above. The leveling procedures may differ from one another based on the manner in which unfilled orders are prioritized or ranked.

The selection of one of the leveling procedures may be based on a number of market factors, conditions, or other characteristics. Given a certain market characteristic, one leveling procedure may be more appropriate for encouraging participation and activity. The selection may be triggered by the detection of a market condition or characteristic.

The selection may be implemented using the processor 202. In some embodiments, the selection is provided via an operator interface generated by the processor 202. Alternatively or additionally, the selection is automated. For example, the processor 202 may obtain market data [block 302], analyze the market data to determine the leveling procedure most appropriate given the conditions indicated by the market data [block 304], and configured the match engine module 106 in accordance with the determination [block 306].

The selection of the leveling procedure may be implemented at any time. For example, the match engine module 106 may be configured to request, confirm, or update the leveling procedure periodically (e.g., daily, weekly, etc.). In one embodiment, the selection is made at the end of each trading day.

In some embodiments, the selection of the leveling procedure (and subsequent configuration of the match engine module 106) may use the methods and systems described in U.S. patent application Ser. No. 13/534,399 (“Multiple Trade Matching Algorithms”), filed Jun. 27, 2012, the entire disclosure of which is hereby incorporated by reference.

The operation of the system 200 further includes receiving an aggressor order [block 308], and allocating, by the processor 202, a primary volume of the aggressor order to a first subset of orders of the set of resting orders based on a the initial or primary matching procedure [block 310]. The allocation results in partial satisfaction of the aggressor order. The primary matching procedure may vary as described above. The residual volume of the aggressor order remaining after the partial satisfaction of the aggressor order is then computed with the processor 202 [block 312].

In some embodiments, the matching procedure is configured to implement an algorithm dependent upon order size. For example, one or more pro rata, or pro rata based, matching algorithms may be used. In some embodiments, the order size dependent algorithm is implemented in one of multiple rounds, or passes, of the primary matching procedure. For example, the primary volume may be allocated in accordance with a split FIFO/Pro Rata algorithm. The primary matching procedure may thus be configured to implement an initial or first matching round in accordance with the FIFO algorithm and a subsequent or second matching round in accordance with a pro-rata algorithm.

The operation of the system 200 further includes arranging, with the processor 202, unfilled orders of the set of resting orders in a ranking based on a leveling procedure independent of order size [block 314]. The manner in which the leveling procedure is order size independent may vary, as described above. In some embodiments, any orders receiving an allocation during the primary matching procedure are excluded from the ranking [block 316]. The exclusion may be limited to situations in which not all of the resting orders receive an allocation during the leveling procedure.

In some embodiments, the leveling procedure is configured to rank the unfilled orders in accordance with timestamps of the unfilled orders. The leveling procedure may thus include a FIFO or Price Time algorithm. In other embodiments, the leveling procedure is configured to execute or allocate the unfilled orders randomly.

Operation of the block 314 to determine the resting order ranking may alternatively or additionally include aggregating resting orders received from a common entity [block 318]. For example, orders associated with a common username, trading firm, or other entity may be aggregated into a single entry in the ranking. In some cases, the aggregation is implemented when the leveling procedure allocates in accordance with, or otherwise includes, a randomization algorithm.

The operation of the system 200 further includes allocating, with the processor 202, a predetermined, level quantity of the aggressor order to each order in a second subset of the set of previously received orders in accordance with the ranking until the residual volume is exhausted [block 320]. The predetermined quantity may be 1-lot or any other number of lots.

Once the allocations of the primary and leveling matching procedures are determined, transaction data indicative of the corresponding trades of the financial product to be executed (i.e., with the first and second subsets of the set of previously received orders) is stored [block 322]. For example, the transaction data may be stored in the trade database 108.

In one embodiment, the initial primary matching algorithms may each comprise a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

For example, the leveling procedure may be configured to incentivize increased trading volume, such as by generating additional liquidity or via encouragement of traders to place orders. For example, the primary matching procedure may be or include a pro-rata algorithm. A pro rata algorithm may, in the case of a low volatility instrument, prevent favoring the first participant to place an order. Generally, pro rata matching algorithms encourage broader participation by market participants. Further, the primary matching procedure may be or include a FIFO algorithm. FIFO algorithms generally favor the first to place an order at a given price and/or those that maintain an order on the order book.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400. The computer system 400 may implement a match engine on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate with a drive unit 406 and other components of the system 400 via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data.

The memory 404 is operable to store instructions 410 executable by the processor 402. The functions, acts or tasks illustrated in the figures or described herein may be performed by the programmed processor 402 executing the instructions 410 stored in the memory 404. The instructions 410 may be loaded or accessed from a computer-readable storage medium 412 in the drive unit 406 or other data storage device. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include an optical or other disk drive unit as the drive unit 406. The disk drive unit 406 may include the computer-readable storage medium 412 in which one or more sets of instructions 410, e.g. software, can be embedded. Further, the instructions 410 may embody one or more of the methods or logic as described herein. In a particular embodiment, the instructions 410 may reside completely, or at least partially, within the memory 404 and/or within the processor 402 during execution by the computer system 400. The memory 404 and the processor 402 also may include computer-readable storage media as discussed above.

The present disclosure contemplates a computer-readable medium that includes instructions 410 or receives and executes instructions 410 responsive to a propagated signal, which may be received via a communication interface 418. The system 400 may be connected to a network 420 to communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the terms “computer-readable medium” and “computer-readable storage medium” include a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable storage medium may be or include a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The disclosed computer programs (also known as a program, software, software application, script, or code) can be written in any form of programming language, including compiled or interpreted languages. The disclosed computer programs can be deployed in any form, including as a standalone program or as a module, component, subroutine, or other unit suitable for use in a computing environment. Such computer programs do not necessarily correspond to a file in a file system. Such programs can be stored in a portion of a file that holds other programs or data (e.g., one or more scripts stored in a markup language document), in a single file dedicated to the program in question, or in multiple coordinated files (e.g., files that store one or more modules, sub programs, or portions of code). Such computer programs can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor may receive instructions and data from a read only memory or a random access memory or both. The essential elements of a computer are a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

FIGS. 5A and 5B depict the application of the system of FIG. 2 according to embodiments implementing leveling allocations in accordance with timestamp and random procedures, respectively. In each embodiment, primary or initial volumes are allocated based on a split FIFO/pro rata matching procedure. In this example, the first round of the procedure implements a FIFO algorithm on 40% of the aggressor order, leaving 60% of the aggressor order to be allocated in accordance with the pro rata algorithm. The percentage split between the first and second rounds may vary in other examples.

In each example, a five lot aggressor order is received for a financial product for which orders A-F are resting on the order book with the order sizes or quantities shown in the tables. The orders are listed in the order in which they were received or added to the order book, with order A having the oldest timestamp. Based on the 40/60 split algorithm, a quantity of two units of the financial product is allocated during the first round (or pass) to order A in accordance with the FIFO algorithm used in the first round of the algorithm.

Due to the large sizes of the resting orders (relative to the aggressor order), all of the resting orders remain unfilled (completely or partially), and are thus eligible for allocation in the second round of the 40/60 split algorithm of the primary matching procedure. The remaining 60% of the aggressor order, three units, may be allocated during the second round. In this embodiment, however, the primary matching procedure is configured with a threshold requirement for the pro rata round. The threshold may effectively establish the minimum lot size for allocation in the pro rata round. The threshold requirement in this case is one unit, although other thresholds may be used. The threshold need not equal the leveling quantity, as it does in this case.

Because none of the unfilled orders meet the threshold, no allocations occur in the second round of the primary matching procedure. To determine whether the pro rata threshold is met, the pro rata proportion of each order is computed by multiplying the quantity remaining unfilled for each order by the remaining quantity of the aggressor order, and dividing the product by the total unfilled order quantity. For Order A, the proportion is (18/498)*3=0.11. Because none of the proportions of the resting orders exceed 1, none of the resting orders receive an allocation in the pro rata round, as shown in the column entitled “Threshold Pro-Rata.”

The residual volume may then be computed by subtracting the allocations in the first and second rounds from the initial quantity of the aggressor order. In this example, the volume remaining after completion of the primary matching procedure is three units, the same quantity remaining after the first round. Oftentimes, the residual volume may differ from the first round quantity. For example, if the quantity of resting order E was 200 instead of 150, then the proportion for order E would be (200/498)*3=1.20. Resting order E would thus be allocated one unit (i.e., 1.2 truncated or rounded down) during the pro rata round, and the residual volume would instead be two units. In some cases, resting order E would be excluded from the leveling procedure as described above.

The leveling procedure may then be applied to the residual volume. In these examples, the leveling procedure is configured with a predetermined level quantity of one (i.e., X=1), i.e., to allocate one unit or lot at a time to the unfilled orders until the residual volume is exhausted. In the embodiment of FIG. 5A, the leveling procedure uses a FIFO or timestamp-based algorithm to rank or prioritize the unfilled orders. Because all of the resting orders remain unfilled (either completely or partially), the ranking corresponds with the initial FIFO ranking shown in the tables. In this embodiment, the oldest orders (i.e., orders A, B, and C) are allocated one lot each, and then the residual volume is exhausted. In other embodiments, order A may be excluded from the leveling procedure as a result of the FIFO allocation in the first round of the primary matching procedure, in which case a 1-lot would be allocated to order D instead. In the embodiment of FIG. 5B, the 1-lots are allocated to those orders randomly identified (i.e., orders B, C, E). Orders may be excluded in the embodiment of FIG. 5B, as described above.

In some embodiments, orders may be aggregated to deter market participants from artificially breaking up an order quantity. In the examples of FIGS. 5A and 5B, if orders B and C both originated or were otherwise associated with a given market participant (e.g., trader, trading firm, etc.), then the two orders would be aggregated and, thus, treated as a single order for purposes of the leveling procedure. Such aggregation may occur regardless of the particular type of leveling algorithm. In the FIFO leveling example of FIG. 5A, the market participant with orders B and C would be allocated only a single lot (e.g., to order B) despite having two of the oldest orders. The leveling procedure would then allocate a 1-lot to order D. The random leveling example of FIG. 5B would similarly limit the market participant to a 1-lot allocation (e.g., to order B).

In embodiments in which the level quantity is other than one (e.g., X=2), the leveling procedure may allocate the level quantity until the residual volume is exhausted or until the remaining quantity is less than the level quantity (e.g., one unit when X=2). The remaining quantity may then be allocated to the next order identified via the leveling matching algorithm.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A computer implemented method for matching an aggressor order for a quantity of a financial product with one or more of a set of previously received unmatched orders for the financial product that are counter to the aggressor order, the method comprising:
allocating a primary volume of the aggressor order to a first subset of orders of the set of previously received orders based on a first matching procedure in partial satisfaction of the aggressor order;
computing, with a processor, a residual volume of the aggressor order remaining after the partial satisfaction of the aggressor order;
arranging unfilled orders of the set of previously received orders in a ranking based on a second matching procedure independent of order size;
allocating a predetermined, level quantity of the aggressor order to each order in a second subset of the set of previously received orders in accordance with the ranking until the residual volume is exhausted; and
storing transaction data indicative of trades of the financial product to be executed with the first and second subsets of the set of previously received orders.

2. The computer implemented method of claim 1 wherein the second matching procedure is configured to rank the unfilled orders in accordance with timestamps of the unfilled orders.

3. The computer implemented method of claim 1 wherein the second matching procedure is configured to rank the unfilled orders randomly.

4. The computer implemented method of claim 1 wherein the first matching procedure is configured to implement a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

5. The computer implemented method of claim 1, wherein the first matching procedure is configured to implement an algorithm dependent upon order size.

6. The computer implemented method of claim 1, wherein the first matching procedure is configured to implement an initial matching round in accordance with a FIFO algorithm and a subsequent matching round in accordance with a pro-rata algorithm.

7. The computer implemented method of claim 1 wherein arranging the unfilled orders comprises aggregating orders of the unfilled orders in the ranking that originate from a common entity.

8. The computer implemented method of claim 1 wherein arranging the unfilled orders comprises excluding from the ranking an order of the unfilled orders belonging to the first subset.

9. The computer implemented method of claim 1 wherein the predetermined, level quantity is a 1-lot quantity.

10. The computer implemented method of claim 1 further comprising selecting the second matching procedure from a plurality of leveling procedures.

11. A system for matching an aggressor order for a quantity of a financial product with one or more of a set of previously received unmatched orders for the financial product that are counter to the aggressor order, the system comprising:
a processor;
a memory coupled with the processor;
first logic stored in the memory and executable by the processor to cause the processor to allocate a primary volume of the aggressor order to a first subset of orders of the set of previously received orders based on a first matching procedure in partial satisfaction of the aggressor order, the first matching procedure is configured to cause the processor to implement an algorithm dependent upon order size;
second logic stored in the memory and executable by the processor to cause the processor to compute a residual volume of the aggressor order remaining after the partial satisfaction of the aggressor order;
third logic stored in the memory and executable by the processor to cause the processor to arrange unfilled orders of the set of previously received orders in a ranking based on a second matching procedure independent of order size;
fourth logic stored in the memory and executable by the processor to cause the processor to allocate a predetermined, level quantity of the aggressor order to each order in a second subset of the set of previously received orders in accordance with the ranking until the residual volume is exhausted; and
fifth logic stored in the memory and executable by the processor to cause the processor to store transaction data indicative of trades of the financial product to be executed with the first and second subsets of the set of previously received orders.

12. The system of claim 11 wherein the second matching procedure is configured to cause the processor to rank the unfilled orders in accordance with timestamps of the unfilled orders.

13. The system of claim 11 wherein the second matching procedure is configured to cause the processor to rank the unfilled orders randomly.

14. The system of claim 11 wherein the first matching procedure is configured to cause the processor to implement an initial matching round in accordance with a FIFO algorithm and a subsequent matching round in accordance with a pro-rata algorithm.

15. The system of claim 11 wherein the third logic is further executable by the processor to cause the processor to aggregate orders of the unfilled orders in the ranking that originate from a common entity.

16. The system of claim 11 wherein the third logic is further executable by the processor to cause the processor to exclude from the ranking an order of the unfilled orders belonging to the first subset.

17. The system of claim 11, further comprising sixth logic stored in the memory and executable by the processor to cause the processor to select the second matching procedure from a plurality of leveling procedures.

18. A computer program product for matching an aggressor order for a quantity of a financial product with one or more of a set of previously received unmatched orders for the financial product that are counter to the aggressor order, the computer program product comprising one or more non-transitory computer-readable storage media having stored thereon computer-executable instructions that, when executed by one or more processors of a computing system, cause the computing system to perform a method, the method comprising:
allocating a primary volume of the aggressor order to a first subset of orders of the set of previously received orders based on a first matching procedure in partial satisfaction of the aggressor order, the first matching procedure is configured to cause the processor to implement an algorithm dependent upon order size;
computing a residual volume of the aggressor order remaining after the partial satisfaction of the aggressor order;
arranging unfilled orders of the set of previously received orders in a ranking based on a second matching procedure independent of order size;
allocating a predetermined, level quantity of the aggressor order to each order in a second subset of the set of previously received orders in accordance with the ranking until the residual volume is exhausted; and
storing transaction data indicative of trades of the financial product to be executed with the first and second subsets of the set of previously received orders.

19. The computer program product of claim 18 wherein the second matching procedure is configured to rank the unfilled orders in accordance with timestamps of the unfilled orders.

20. The computer program product of claim 18 wherein the second matching procedure is configured to rank the unfilled orders randomly.

21. The computer program product of claim 18 wherein arranging the unfilled orders comprises aggregating orders of the unfilled orders in the ranking that originate from a common entity.

22. The computer program product of claim 18 wherein arranging the unfilled orders comprises excluding from the ranking an order of the unfilled orders belonging to the first subset.

23. A system for matching an aggressor order for a quantity of a financial product with one or more of a set of previously received unmatched orders for the financial product that are counter to the aggressor order, the system comprising:
means for allocating a primary volume of the aggressor order to a first subset of orders of the set of previously received orders based on a first matching procedure in partial satisfaction of the aggressor order;
means for computing a residual volume of the aggressor order remaining after the partial satisfaction of the aggressor order;
means for arranging unfilled orders of the set of previously received orders in a ranking based on a second matching procedure independent of order size;
means for allocating a predetermined, level quantity of the aggressor order to each order in a second subset of the set of previously received orders in accordance with the ranking until the residual volume is exhausted; and
means for storing transaction data indicative of trades of the financial product to be executed with the first and second subsets of the set of previously received orders.
